(19) United States
(12) Patent Application Publication
(10) Pub. No.: US 2024/0367660 A1
(43) Pub. Date: Nov. 7, 2024

(54) METHODS, MOBILE APPARATUS, AND ELECTRONIC DEVICE FOR CONTROLLING VEHICLE, COMPUTER PROGRAM, AND STORAGE MEDIUM

(71) Applicant: IDEMIA IDENTITY & SECURITY USA LLC, Reston, VA (US)

(72) Inventors: Teresa WU, Reston, VA (US); Hal WIEDIGER, Reston, VA (US)

(21) Appl. No.: 18/143,153

(22) Filed: May 4, 2023

(51) Int. Cl. B60W 40/08

(52) U.S. Cl. CPC B60W 40/08; B60W 2040/0809; B60W 2554/4041

(57) ABSTRACT

A method for controlling a vehicle is provided. The method is implemented by a mobile apparatus configured to be connected to and disconnected from the vehicle through a communication interface. The method includes: connecting to the vehicle via the communication interface; determining that a user associated with the apparatus is authorized to operate the vehicle; and controlling the vehicle via the communication interface to enable the vehicle to perform a function that affects the operation of the vehicle.

### TECHNICAL FIELD

The present disclosure relates generally to the field of vehicle control, and, in particular, to methods, a mobile apparatus and an electronic device for controlling a vehicle, a computer program, and a storage medium.

### BACKGROUND

Digital car keys are an innovative technology that is widely used today. Through various communication technologies such as near-field communication (hereinafter “NFC”), ultra-wideband (hereinafter “UWB”) and Bluetooth low energy (hereinafter “BLE”), smart devices such as NFC cards, smart phones and smart watches can be turned into car keys, for example through a mobile app linked to an account. This enables functions such as keyless entry, keyless start, key sharing, remote vehicle control, etc., providing users with a smarter and more convenient experience.

For example, keyless entry will unlock a car as the driver approaches it, without the need for a physical key, and keyless start will start the car at the press of a button built into the car, without the need to insert a physical key into the ignition.

Theft of a device such as a digital car key still allows an unauthorized person to enter and use a vehicle.

Also, when an account is used, takeover of the account by an unauthorized person is still a possibility.

Accordingly, digital keys technologies are sometimes combined with user verification using biometrics such as facial recognition, or with driver qualification authentication using credentials such as information extracted from a driver's license. Examples of such verification or authentication processes can be found in the US Patent Publication No. U.S. Pat. No. 11,042,619B2 and the European Patent Application Publication No. EP3674162A1.

More secure solutions are still required.

### SUMMARY

In a first aspect, the present disclosure provides a method for controlling a vehicle. The method is implemented by a mobile apparatus configured to be connected to and disconnected from the vehicle through a communication interface. The method includes:
connecting to the vehicle via the communication interface;
determining that a user associated with the apparatus is authorized to operate the vehicle (for example through biometrics); and
controlling, after the vehicle has been powered up, the vehicle via the communication interface to enable the vehicle to perform a function that affects the operation of the vehicle.

In contrast with the solutions of the prior art, the above method proposes to implement enabling a function of the vehicle in the mobile apparatus. This function differs from starting the vehicle/powering up the vehicle as it is performed after the vehicle has been powered up/when the vehicle is powered up. Hence, the mobile apparatus differs from a key, although it can also implement the functions of a key.

As a function of the vehicle is enabled through the mobile apparatus, an additional level of security is reached.

Also, the above mobile apparatus is associated with a user. For example, it can be a personal device. In particular, the mobile apparatus may be independent from the vehicle, can be distinct, i.e., a standalone unit, or is not part of the vehicle.

The vehicle may be an autonomous or human-driven (e.g., automatic or manual transmission type) vehicle. In particular, it may be a vehicle of any of the 6 driving automation levels defined by the Society of automotive engineers (hereinafter “SAE”).

According to a particular embodiment, the method may further include, prior to the controlling step, a step of determining whether the user associated with the apparatus is on a seat of the vehicle. Accordingly, the controlling step is performed if it is determined that the user is on a seat of the vehicle. The seat can be the driver's seat and/or a passenger seat.

For example, if the vehicle is an autonomous taxi, it may be determined at this step whether the user associated with the apparatus is on any passenger seat of the vehicle.

By way of example, the function that affects operation of the vehicle can be chosen from the group including: a function that affects operation of a drivetrain of the vehicle, and a function that affects a braking system of the vehicle.

According to a particular embodiment, the function is implemented by an operating system having a first portion executed in the mobile apparatus and a second portion that differs from the first portion executed in a computing device of the vehicle.

In this particular embodiment, with the operating system being split in two portions, it appears that the operating system cannot be executed fully without execution of the first portion in the mobile apparatus.

By way of example, the first portion of the operating system is configured to manage a program for determining the value of a vehicle configuration parameter associated with the function according to a user input, and the second portion of the operating system is configured to manage a program for controlling the function according to the value of the configuration parameter. More specifically, the user input may be a selection made by the user from various drive modes of the vehicle, where the drive modes may alter one or more of the suspension, steering, transmission, throttle, brakes, fuel injection, and overall performance of a vehicle.

Alternatively or additionally, the first portion of the operating system may be configured to authenticate the mobile apparatus, or may be configured to manage a program for authenticating the mobile apparatus.

According to a particular embodiment, prior to the controlling step, the method includes generating a control signal based on data received from a sensing device of the vehicle, the controlling step including transmitting the control signal to an actuator device of the vehicle to enable the actuator device to perform the function.

In this particular embodiment, the function affects operation of an actuator of the vehicle, for example to affect movement of the vehicle. A sensing device of the vehicle is also used to provide information to the mobile apparatus that will then output the control signal.

The disclosure is not limited to functions that control an actuator (e.g., a function that controls engine ignition/start), but also to other functions such as: a function that affects a temperature (air conditioning or heating system), a function that affects a display screen of the vehicle, global positioning system (hereinafter “GPS”) navigation.

According to a particular embodiment, prior to determining that the user is authorized to operate the vehicle, the method further includes receiving information identifying the user (for example biometric data) and/or digital credential data from the user. Accordingly, the determining step further includes a step of authenticating the user based on the received information and/or the received digital credential data.

For example, the digital credential data indicates qualification, competence or clearance of the user to control the vehicle. The digital credential data may include one or more pieces of the following information: information indicating driving skills of the user (e.g., information extracted from a driver's license or a digital skill test certificate, for example the types of vehicles that a user can drive), information relating to a car insurance policy associated with the user (e.g., a digital insurance certificate), information showing that the user belongs to a group of authorized users (e.g., a digital vehicle rental contract, a digital membership certificate or a digital employment contract), payment information to authorize future financial transactions when the user's account balance is insufficient (for example, in the case of a traffic violation), and information specifying geographic locations that the user is allowed to access using the vehicle.

According to a particular embodiment, after the determining step, the method further includes verifying whether the authorized user controls the vehicle and/or whether the user is still authorized to operate the vehicle. This verification step may be performed continuously or at regular intervals, or may be triggered by a predefined condition.

In this particular embodiment, it is checked that the user is actually operating the vehicle (for example behind the driving wheel in a car), and/or it is checked that at a given instant, the user is still authorized to operate the vehicle. This further reinforces the security of the method.

According to a particular embodiment, the method further includes transmitting a digital key to the vehicle to request control of the vehicle. By way of example, this step may be performed before the mobile apparatus starts controlling the vehicle and the digital key may be used by the vehicle to authenticate the mobile apparatus or the user associated with the mobile apparatus. Or, the step may be performed after the mobile apparatus starts controlling the vehicle. It may be performed at regular intervals or when a predefined condition is met in order for the mobile apparatus to continue controlling the vehicle. For example, the condition may be that the mobile apparatus receives a request from the vehicle.

Accordingly, the vehicle can be further secured.

According to a particular embodiment, the method further includes locating the vehicle using GPS data, and verifying if, in accordance with the location of the vehicle, the user is authorized to operate the vehicle at this location.

By way of example, when the user is not authorized to operate the vehicle at this location, the vehicle may be remotely stopped and the engine may be remotely locked.

This particular embodiment prevents a user from operating the vehicle beyond an authorized region. This particular embodiment is particularly useful when the vehicle is part of a fleet of vehicles, for example used by employees along specific routes.

The GPS may be acquired from the mobile apparatus and/or from the vehicle. In particular, the method may further include a step of comparing GPS data acquired from the mobile apparatus and GPS data acquired from the vehicle. Accordingly, the verifying step is performed when the GPS data acquired from the mobile apparatus and the GPS data acquired from the vehicle are consistent. Otherwise the user is not authorized to operate the vehicle.

According to a particular embodiment, the method further includes generating an alert signal rendered in the vehicle or configured to be rendered to a distant third party when a predefined condition is met.

In this particular embodiment, the alert signal can indicate that the vehicle may stop after a given duration (typically the alert rendered in the vehicle). The alert signal can be a visual signal displayed on a screen to be rendered, or an audio signal.

By way of example, the predefined condition may be that a prohibited control operation is performed on the vehicle, that an emergency occurs, or that one or more types of digital credential data (e.g., the vehicle rental contract) of the user is about to expire. The prohibited control operation may be detected when the GPS data indicates that the vehicle is outside a given geographic region, when it is determined that the user associated with the apparatus is not authorized to operate the vehicle, when it is determined that the user currently controlling the vehicle is not the authorized user or is no longer authorized to operate the vehicle, or, when the verification of the digital key fails.

In a second aspect, the present disclosure provides another method for controlling a vehicle. The method is implemented by a server and includes:
receiving a request from a mobile apparatus associated with a user for permission to operate the vehicle;
determining that the user associated with the mobile apparatus is authorized to operate the vehicle; and
communicating with the mobile apparatus to authorize the user to control the vehicle.

As such, a vehicle operator implemented on a server is able to control user access to the vehicle in a flexible, secured and convenient way. This method benefits from the advantages of the previously presented method for controlling a vehicle. By way of example, the vehicle belongs to a fleet of vehicles.

The mobile apparatus according to any embodiment of the first aspect and the second aspect may be the same apparatus, and thus the method in the first aspect and the method in the second aspect may be interrelated.

In a third aspect, the present disclosure provides a mobile apparatus for controlling a vehicle. The mobile apparatus is configured to be connected to and disconnected from the vehicle through a communication interface. The mobile apparatus includes: the communication interface, configured to connect the apparatus to the vehicle; an authentication module configured to determine that a user associate with the apparatus is authorized to operate the vehicle; and a controller configured to control, after the vehicle has been powered up, the vehicle via the communication interface to enable the vehicle to perform a function that affects the operation of the vehicle.

This mobile apparatus can be adapted to perform any one of the above embodiments of the method for controlling a vehicle in the first aspect.

For example, this mobile apparatus can have the structure of a computing system, for example a portable computing system such as a phone.

In a fourth aspect, the present disclosure provides an electronic device for controlling a vehicle. The electronic device includes a transceiver; one or more processors; and one or more storage devices storing instructions which, when executed by the one or more processors, enable the one or more processors to: control the transceiver to receive a request from a mobile apparatus associated with a user for permission to operate the vehicle; determine that the user is authorized to operate the vehicle; and control the transceiver to communicate with the mobile apparatus to allow the user to control the vehicle.

The electronic device can be adapted to perform any embodiment of the method for controlling a vehicle in the second aspect.

In one particular embodiment, the steps of the method for controlling a vehicle in the first or second aspect are determined by computer program instructions.

Consequently, the disclosure is also directed to a computer program for executing the steps of a method for controlling a vehicle as described above in the first or second aspect when this program is executed by a computer.

This program can use any programming language and take the form of source code, object code or a code intermediate between source code and object code, such as a partially compiled form, or any other desirable form.

This program can use any programming language and take the form of source code, object code or a code intermediate between source code and object code, such as a partially compiled form, or any other desirable form.

The disclosure is also directed to a computer-readable information medium containing instructions of a computer program as described above. In particular, the information medium may be non-transitory.

The information medium can be any entity or device capable of storing the program. For example, the medium can include storage means such as a ROM, for example a CD ROM or a microelectronic circuit ROM, or magnetic storage means, for example a diskette (floppy disk) or a hard disk.

Alternatively, the information medium can be an integrated circuit in which the program is incorporated, the circuit being adapted to execute the method in question or to be used in its execution.

### BRIEF DESCRIPTION OF THE DRAWINGS

Embodiments of the disclosure and advantages thereof will be described below in detail, by way of example, with reference to the accompanying schematic drawings introduced as follows.

FIG. 1 illustrates an exemplary system in accordance with one or more embodiments disclosed herein.

FIG. 2 is a flowchart illustrating a method for controlling a vehicle in accordance with an example disclosed herein.

FIGS. 3-10 are more precise flow charts of the example of FIG. 2.

FIG. 11 is a flow chart illustrating another method for controlling a vehicle in accordance with another example.

FIG. 12 is a block diagram illustrating a mobile apparatus in accordance with another example.

FIG. 13 is a block diagram illustrating an example structure corresponding to the example of FIG. 12.

FIG. 14 is a block diagram illustrating an electronic device in accordance with another example.

For simplicity and clarity of illustration, the same reference numerals will be used throughout the figures to refer to the same or like parts, unless indicated otherwise.

### DESCRIPTION OF PARTICULAR EMBODIMENTS

We will now describe methods and systems for controlling a vehicle, that overcome the problems associated with a stolen key or a loss of key and which, overall, add a level of security to operating of a vehicle.

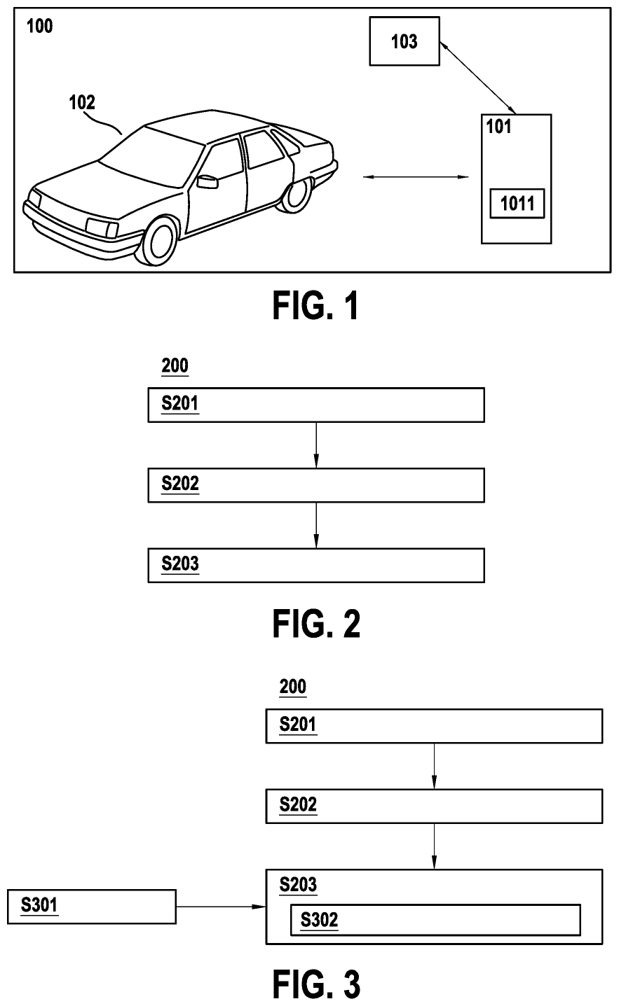

FIG. 1 illustrates an example system 100 in which various embodiments of the present disclosure may be employed. As illustrated by FIG. 1, the system 100 includes a mobile apparatus 101 and a vehicle 102. Although shown as a car in FIG. 1, the vehicle 102 may be any type of vehicle, such as a motorcycle, a train, or an airplane.

The mobile apparatus 101 is configured to be connected to and disconnected from the vehicle 102 through one or more communication interfaces, illustrated by the communication interface 1011 of the mobile apparatus 101. As used herein, the term “communication interface” refers to an interface, usually designed to a specific telecommunication standard that enables one electronic device to transmit information to or receive information from another electronic device.

As such, the mobile apparatus 101 may be connected to the vehicle 102 via a communication link when implementing the method for controlling a vehicle, which differentiates the mobile apparatus 101 from any computing apparatus or on-board electronic module that must be mounted on the vehicle 102 via one or more non-communicating connection parts to prevent it from moving while the vehicle 102 is in motion. The communication interface 1011 may enable wired or wireless communication between the vehicle 102 and the mobile apparatus 101. The communication interface 1011 may include one or more of a wireless transceiver such as an antenna or an antenna system, transmitter/receiver devices used in a cabled system, and an input/output port such as a serial port (e.g., a recommended standard 485 interface), a parallel port, a controller area network (hereinafter “CAN”) interface, a serial peripheral interface (hereinafter “SPI”), a universal serial bus (hereinafter “USB”) port, a digital radio frequency (hereinafter “DigRF”) interface, and etc.

In fact, by being configured to be connected to and disconnected from the vehicle via a communication interface, what is meant is that no additional tool is required to connect/disconnect the mobile apparatus, and it may also not be required to dismount an element of the vehicle with a tool to connect/disconnect the mobile apparatus. In particular, when the connection is wired, it is not necessary to open the hood of the vehicle to connect the mobile apparatus, which can be connected in the interior of the vehicle.

By way of example, the vehicle 102 may include a slot to accommodate the mobile apparatus. The slot may be a compartment or storage area within the interior of the vehicle 102 to hold the apparatus, and may be located in the center console, on the door panels, on the dashboard, or in another location.

The mobile apparatus 101 may be any type of computing device that is suitable or adaptable for performing the steps of the method for controlling a vehicle. It may be handholdable by a user. Examples of the mobile apparatus 101 include mobile phones, laptop computers, tablets, wearable devices, or any other suitable mobile computing device.

By way of example, the system may further include a remote electronic device (e.g., a server) 103 which communicates with the mobile apparatus 101.

FIG. 2 illustrates a method 200 for controlling the vehicle 102. The method is implemented by the mobile apparatus 101 described in reference to FIG. 1 and includes the following steps S201-S203.

In step S201, the mobile apparatus 101 connects to the vehicle 102 via the communication interface 1011.

This may be performed as explained above in relation to FIG. 1.

In step S202, mobile apparatus 101 verifies whether a user associated with the apparatus 101 is authorized to operate the vehicle 102.

If the verification is successful, then after the vehicle 102 has been powered up (it should be noted that the vehicle can be powered up even before step S202), the mobile apparatus 101 performs step S203 of controlling the vehicle via the communication interface 1011 to enable the vehicle 102 to perform a function that affects operation of the vehicle 102.

By way of example, the term “operation of the vehicle” refers to an active/functioning state (of the vehicle) that is powered by internal engine(s). Moreover, the expression “a function that affects operation of the vehicle” means that the function changes such a state of the vehicle when the vehicle is in the state, or that the function causes the vehicle to enter into such a state.

For example, the function mentioned at step S203 may be a function that stops the vehicle 102 moving or changes the direction or speed of the motion of the vehicle 102, or a function that is essential to a procedure of causing the vehicle 102 to move from a resting state after the vehicle 102 has been powered up (e.g., the function may be to put the vehicle 102 in the drive gear).

As such, compared with the existing technologies as described in the background section herein, the method for controlling the vehicle is able to affect the operation of a vehicle using a mobile apparatus after the vehicle has been power up, providing a way of controlling and securing the vehicle.

In an example compatible with any other example herein, the vehicle control of step S203 may be implemented by the mobile apparatus 101 transmitting signal(s) to the vehicle 102 via one or more communication interfaces represented by the interface 1011. The transmitted signal(s) may be received by a control unit or actuator device of the vehicle 102, which in turn performs the function.

A control unit of the vehicle 102 is an onboard computing device including one or more processors and one or more storage devices. It may be configured to receive signals from one or more onboard sensing devices of the vehicle 102 or from one or more other control units of the vehicle 102, process any received signal, and transmit signals to one or more other control units or onboard actuator devices of the vehicle 102. Examples of the control unit include an electronic control unit (hereinafter “ECU”), a vehicle control unit (hereinafter “VCU”), a microcontroller control unit (hereinafter “MCU”), a body control module (hereinafter “BCM”), a domain control unit (hereinafter “DCU”), or any other kind of vehicle controller.

An actuator device of the vehicle 102 is an onboard component that is configured to produce a motion by converting energy (such as electrical, air or hydraulic) to mechanical force. Examples of the actuator device include electric motors (such as starter motor, power steering motor and variable valve timing actuator), hydraulic motors, pneumatic motors and etc.

In a further example compatible with any other example herein, the mobile apparatus 101 may be configured to be connected to a sensing device of the vehicle 102 via a communication interface of the mobile apparatus 101, and to an actuator device of the vehicle 102 via the communication interface 1011. The mobile apparatus 101 is configured to receive data from the sensing device. The sensing device may include a sensor that is configured to measure physical input from its environment and convert it into data that can be interpreted by a control unit of the vehicle 102.

Accordingly, as illustrated by FIG. 3, prior to step S203, the method 200 further includes a step S301 of generating a control signal based on the data received from the sensing device, and step S203 includes a sub-step S302 of transmitting the control signal to the actuator device via the communication interface 1011 to enable the actuator device to perform the function.

In still another example compatible with any example herein, the function is implemented by an operating system (hereinafter “OS”) having a first portion executed in the mobile apparatus 101 and a second portion that differs from the first portion executed in a computing device of the vehicle 102. The first portion may include the core of the operating system. The computing device of vehicle 102 may be one of the control units described above.

For instance, the first portion is stored in the mobile apparatus 101 and the second portion of the OS is stored in the vehicle 102. The OS may be one that manages software and hardware on the vehicle 102, in a manner known in itself for an OS executed on a single computing device.

As such, the implementation of the function and of the OS will depend on the connection between the mobile apparatus 101 and the vehicle 102.

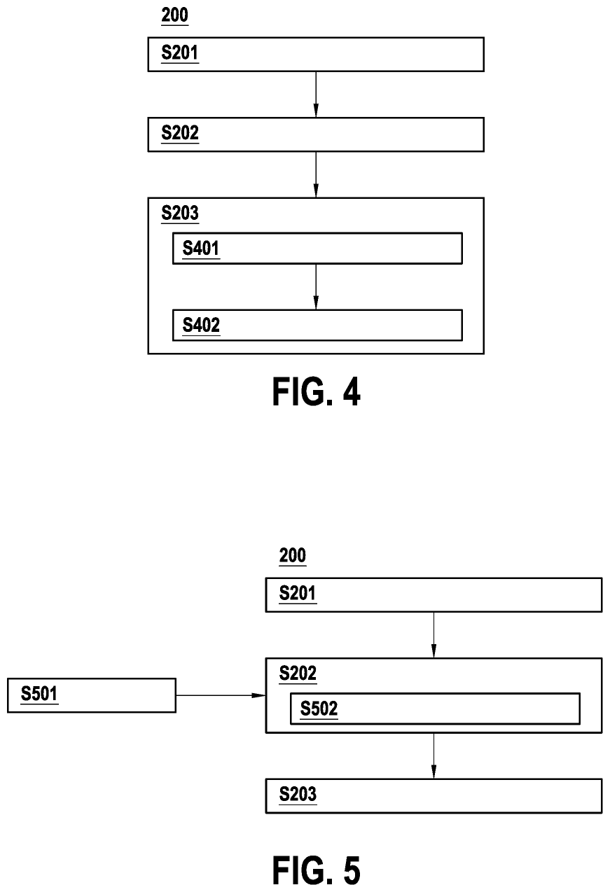

Accordingly, as illustrated by FIG. 4, during step S203, the mobile apparatus 101 may control the vehicle 102 by a sub-step S401 of executing the first portion of the OS that is stored on the mobile apparatus 101 and a sub-step S402 of enabling the vehicle 102 to execute the second portion of the OS that is stored on the vehicle 102.

In still another example as illustrated by FIG. 5, which is compatible with any other example herein, the user associated with the apparatus 101 may be a user from whom the apparatus 101 has received information for authenticating the user at step S501. Accordingly, step S202 further includes a step S502 of authenticating the user based on the received information. The mobile apparatus 101 may be configured to perform step S502 within a given time period after reception of the information.

In particular, the information for authenticating the user may include information identifying the user and/or digital credential information.

The information identifying the user may include biometric data collected by a biometric sensing device of the mobile apparatus 101 or of the vehicle 102 in communication with the mobile apparatus 101. The biometric sensing device may include a camera, a fingerprint or iris sensor, and etc. Additionally or alternatively, the information identifying the user may include any form of non-biometric information that identifies the user. For example, a digital identification document (e.g., a passport) or information extracted from the digital identification document, a user identifier bound to a particular organizational identity (e.g., an employee identification number), or an authenticated mobile phone number or email address. Such non-biometric information may be received via a wired or wireless communication interface or an input device (that receives user inputs, such as a keyboard, a touch screen, a microphone, or a camera) of the mobile apparatus 101 or of the vehicle 102.

The digital credential data may indicate the user's qualification, competence or clearance to control the vehicle 102. Examples of the digital credential data include information indicating driving skills of the user (e.g., information extracted from a driver's license or a digital skill test certificate), information relating to a car insurance policy associated with the user (e.g., a digital insurance certificate), and information showing that the user belongs to a group of authorized users (e.g., a digital vehicle rental contract or a digital membership certificate). The digital credential data may be received via a wired or wireless communication interface or an input device of the mobile apparatus 101.

Information identifying authorized users and/or digital credential data of authorized users may be pre-stored in the mobile apparatus 101 so that during the step S502 the mobile apparatus 101 may check the validity of the information received from the user locally.

In addition, if at least a portion of this pre-stored information/data has expiry time or date(s), the mobile apparatus 101 may update this portion regularly or in response to the occurrence of a predefined event (e.g., when an expiry date is reached) by synchronizing this portion with the database(s) on one or more remote third-party devices (e.g., servers). Or, if the mobile apparatus 101 cannot find any pre-stored information/data which matches the information received from the user at the step S501, the mobile apparatus 101 may communicate with the one or more remote third-party devices to retrieve information/data that matches the information received from the user. The one or more remote third-party devices may be owned by government agencies and/or the owner of the vehicle 102.

Alternatively, during step S502 the mobile apparatus 101 may transmit the information received from the user at step S501 to the remote electronic device (e.g., a server) 103 as illustrated by FIG. 1 for the authentication and then receive the result of the authentication from the remote electronic device 103. In particular in addition to the information received the user at step S501, the mobile apparatus 101 may further transmit information identifying itself and/or the vehicle to the remote electronic device 103 for the authentication.

By way of example, the digital credential information received from the user may further include information specifying geographic regions that the user is allowed to access using the vehicle, and the validity of such information is checked during step S502. Or, such information may be per-stored in association with the user in the mobile apparatus 101 or the remote electronic device 103.

Accordingly, the step S202 may further include a step of determining whether the user is authorized to operate the vehicle 102 in the current geographic region of the vehicle 102 or in a destination specified by the user.

In still another example which is compatible with any other example herein, the verification step S202 may be based on a rule that only one user may operate the vehicle 102 in a given time slot, or that multiple users from an authorized group (e.g., drivers of a fleet of vehicles) may operate the vehicle in a given time slot.

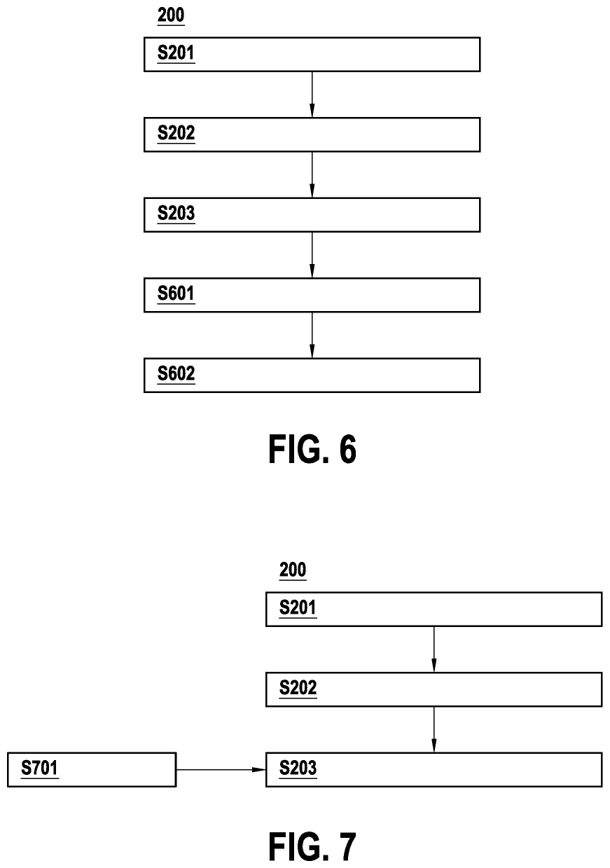

In still another example as illustrated by FIG. 6, which is compatible with any other example herein, the method 200 includes a step S601 of locating the vehicle 102 using GPS data, and a step S602 of verifying whether the user is authorized to operate the vehicle at a location indicated by the GPS data. The GPS data may be collected by the mobile device 101 or the vehicle 102.

While FIG. 6 illustrates the steps S601-S602 as being performed independently of the step S202, the step S602 may alternatively be a sub-step that is included in the step S202.

By way of example, the steps S601 and S602 may be performed when the user is operating the vehicle 102 after the controlling step S203. The step S602 may be performed locally at the mobile apparatus 101, or may be performed by the mobile apparatus 101 transmitting the GPS data to the remote electronic device 103 and receiving the verification result from the electronic device 103.

In still another example as illustrated by FIG. 7, which is compatible with any other example herein, the method 200 further includes, prior to the controlling step, a step S701 of determining whether the user associated with the apparatus 101 is on the driver's seat. Accordingly, the controlling step 203 is performed if it is determined that the user is on the driver's seat. The step S701 may be performed before or after the step S202.

By way of example, the mobile apparatus 101 may determine whether the user is on the driver's seat by checking image(s) or video(s) of the user taken by a camera of the mobile apparatus 101, and/or by receiving signal(s) from one or more sensing devices of the vehicle 102, where the one or more sensing devices may include a camera, a pressure sensor in the driver's seat, and/or, the seat belt buckle.

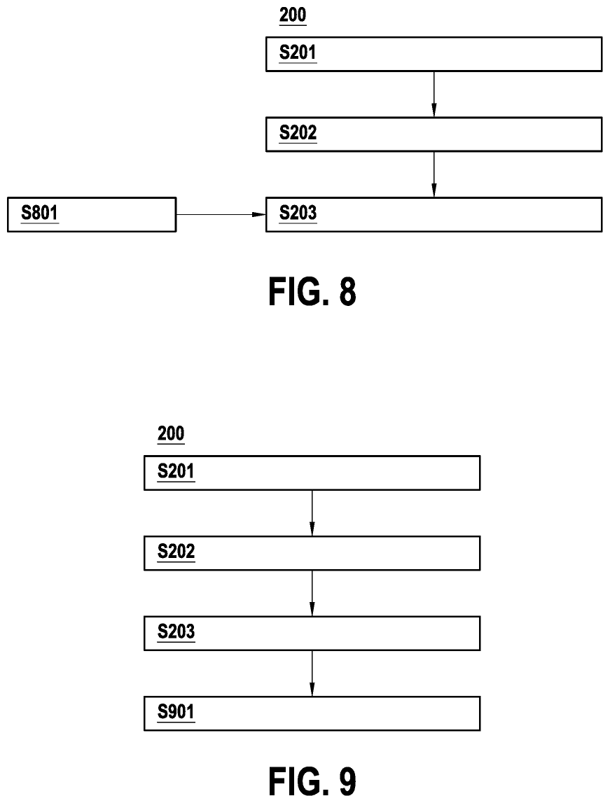

In still another example as illustrated by FIG. 8, which is compatible with any other example herein, the method 200 further includes a step S801 of transmitting a digital key to the vehicle 102 to request control of the vehicle 102. The digital key may be used by the vehicle 102 to authenticate the user or the mobile apparatus 101, for indicating a level of control that has been granted to the user, or for decrypting an OS or a portion of an OS that is stored on the vehicle 102. Moreover, the digital key may be a temporary key that expires after a certain amount of time from its release or at a given date and time.

As illustrated by FIG. 8, step S801 may be performed prior to step S203 to request that the mobile apparatus 101 start to control the vehicle 102. In particular, the digital key may be first transmitted from the remote electronic device 103 to the mobile apparatus 101, e.g., to indicate the success of the verification associated with step S202.

Accordingly, step S203 may be implemented in response to information received from the vehicle 102 that indicates successful verification of the digital key by the vehicle 102.

In addition, step S801 may also be performed after step S203. It may be performed at regular intervals or when a predefined condition is met to request to continue controlling the vehicle 102. For example, the condition may be that the mobile apparatus 101 receives a request from the vehicle 102. The vehicle 102 may send the request to the mobile apparatus 101 if the previous digital key has expired.

In still another example as illustrated by FIG. 9, which is compatible with any other example herein, the method 200 further includes a step S901 which is to be performed after the mobile apparatus 101 determines that the user associated with it is authorized to operate the vehicle in step S202. During step S901 the mobile apparatus 101 verifies whether the vehicle 102 is under the control of the authorized user or whether the user is still authorized to operate the vehicle 102. Step S901 may be performed continuously or at regular intervals, or may be triggered by a predefined condition such as detecting that a door of the vehicle 102 has been unlocked or detecting that the seat belt at the driver's seat has been unbuckled.

In particular, the verification process of step S901 may be implemented by comparing (biometric or non-biometric) identification information of a user currently in control of the vehicle 102 with the corresponding identification data of the authorized user, or by determining whether non-biometric identification information or digital credential data received from the user currently in control of the vehicle is still valid.

Accordingly, a sensing device, input device, or communication interface of the mobile apparatus 101 or the vehicle 102 may be configured to collect automatically or request to collect/receive the information for authenticating the user currently in control of the vehicle 102 before step S901 is performed.

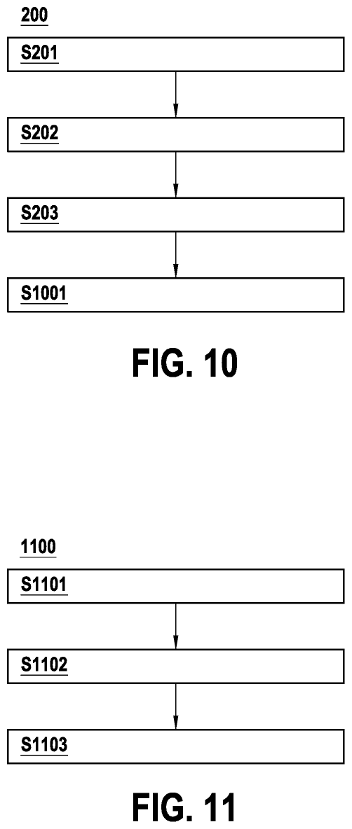

In still another example as illustrated by FIG. 10, the method 200 further includes a step S1001 of generating an alert signal rendered in the vehicle 102 or configured to be rendered to a distant third party such as the electronic device 103 when a predefined condition is met. The condition may be that a prohibited control operation is performed on the vehicle 102, that an emergency occurs, or that one or more types of digital credential data (e.g., the vehicle rental contract) of the user is about to expire.

In particular, the step S1001 may be performed when the GPS data indicates that the vehicle 102 is outside a given geographic region, when it is determined that the user currently controlling the vehicle 102 is not the authorized user or is no longer authorized to operate the vehicle, when the verification of the digital key fails, or, when the verification associated with the step S202 fails.

The alert signal may be rendered in an audible, visible, or tangible form (e.g., a vibration). Moreover, during step S1001 the alert signal may be rendered using a display, an audio component (e.g., a speaker) or a vibration mechanism of the mobile apparatus 101. Or, the mobile apparatus 101 may transmit the generated alert signal to the vehicle 102 to raise the alert.

Further, when an alert signal is generated to remind the user the amount of time remaining before expiration of the vehicle rental contract, the mobile apparatus 101 or the vehicle 102 may provide an option for an extension of the period of vehicle control. Step S202 may be implemented again to re-authenticate the user after the user accepts the extension terms.

As can be appreciated from description above, though FIG. 10 illustrates the step S1001 as being performed after the control step S203, step S1001 may alternatively be carried out without the execution of control step S203.

As shown above, various examples of the present disclosure allow the mobile apparatus 101 to handle necessary communication with remote devices represented by the electronic device 103, thereby eliminating the need for the vehicle 102 to be equipped with a software or hardware module configured to communicate with any remote device (an example of such a module is a communication chip using cellular communication technology).

FIG. 11 illustrates another method 1100 for controlling a vehicle. The method is implemented by the electronic device 103 and includes the following steps S1101-S1103.

The electronic device 103 may be a high-performance computer, a server, a user device (e.g., a laptop computer, a home desktop computer, a mobile device such as a tablet, a smart phone, a wearable device, etc.), a platform having one or more corresponding application programming interfaces (hereinafter “APIs”), a cloud infrastructure, or any other computing device suitable for performing steps of the method 1000 for controlling a vehicle or managing a fleet of vehicles.

In step S1101, the electronic device 103 receives a request from a mobile apparatus associated with a user for permission to operate a vehicle. For example, the mobile apparatus may be the mobile apparatus 101 and the vehicle it requests to operate may be the vehicle 102. Moreover, the vehicle may belong to a fleet.

The request may include the information for authenticating the user as described in connection with above described method 200 for controlling a vehicle, information identifying the mobile apparatus, and/or, or information identifying the vehicle.

At the step S1102, the electronic device 103 verifies whether the user is authorized to operate the vehicle.

In particular, step S1102 may include the electronic device 103 verifying whether the mobile apparatus is a registered or authorized apparatus.

If the verification is successful, then at step S1103, the electronic device 103 communicates with the mobile apparatus to allow the user to control the vehicle. For example, the electronic device 103 may send one or more signals to the mobile apparatus to allow the user to control the vehicle.

As can be appreciated, the method 200, which is executed by the mobile apparatus 101, and the method 1100, which is executed by the electronic device 103, can be implemented in conjunction with each other.

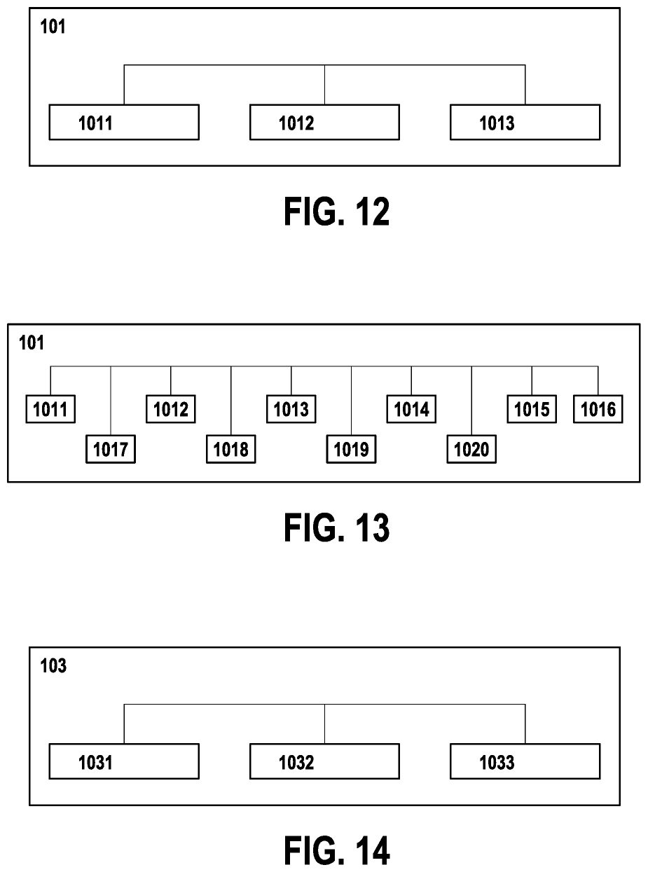

FIG. 12 illustrates a mobile apparatus 101, here a mobile apparatus configured to be used in the method for controlling a vehicle described in reference to FIGS. 1-10. Apart from the communication interface 1011, which is configured to connect the mobile apparatus 101 to the vehicle 102, the mobile apparatus 101 further includes an authentication module 1012 and a controller 1013. The authentication module 1012 is configured to determine that a user associated with apparatus 101 is authorized to operate the vehicle 102, and the controller 1013 is configured to control, after the vehicle 102 has been powered up, the vehicle 102 via the communication interface 1011 to enable the vehicle 102 to perform a function that affects the operation of the vehicle 102.

In an example compatible with any other example herein, the controller 1013 may be further configured to perform steps S401 and S402, as described above in connection with FIG. 4.

In still another example as illustrated by FIG. 13, which is compatible with any other example herein, the mobile apparatus 101 may further include a signal generator module 1014 configured to perform step S301 as described above in connection with FIG. 3, and the controller 1013 is further configured to perform step S302.

In still another example as illustrated by FIG. 13, which is compatible with any other example herein, the mobile apparatus 101 includes a receiving module 1015 configured to perform step S501 and S502 as described above in connection with FIG. 5. Though the receiving module 1015 is illustrated as being separate from the communication interface 1011 in FIG. 13, hardware implementation of the receiving module 1015 may alternatively include or be part of the communication interface 1011. As can be appreciated from the example described above in connection with FIG. 5, example hardware for implementing the receiving module 1015 include one or more of biometric sensing devices, communication interfaces, and input devices. Accordingly, the authentication module 1012 is configured to perform the step S502.

In still another example as illustrated by FIG. 13, which is compatible with any other example herein, the mobile apparatus 101 further includes a location module 1016 configured to perform step S601 as described above in connection with FIG. 6, and a verification module 1017 configured to perform the operation S602. As can be appreciated from the example described above in connection with FIG. 6, though illustrated as being separate from the authentication module 1012 in FIG. 13, the verification module 1017 may alternatively be part of the authentication module 1012.

In still another example as illustrated by FIG. 13, which is compatible with any other example herein, the mobile apparatus 101 further includes a determination module 1018 configured to perform the step S701 as described above it connection with FIG. 7.

In still another example as illustrated by FIG. 13, which is compatible with any other example herein, the mobile apparatus 101 further includes a transmission module 1019 configured to perform the step S801 as described above in connection with FIG. 8. Though the transmission module 1019 is illustrated as being separate from the communication interface 1011 in FIG. 13, hardware implementation of the transmission module 1019 may alternatively include or be part of the communication interface 1011.

In still another example as illustrated by FIG. 13, which is compatible with any other example herein, the mobile apparatus 101 further includes an alerting module 1020 configured to perform step S1001 as described above in connection with FIG. 10.

The modules 1012 and 1014-1020 and the controller 1013 may be developed in the form of hardware (such as one or several integrated circuits), software (including firmware, resident software, micro-code, and so forth), or a combination of software and hardware.

In still another example which is compatible with any other example herein, the mobile apparatus 101 may include one or more of processors and storage devices. The one or more storage devices may include computer-readable instructions which, when executed by the one or more processors, enable the one or more processors to perform the method 200 according to any one of the examples described above.

FIG. 14 illustrates the electronic device 103. The electronic device 103 includes a transceiver 1031 configured to receive or transmit signals under the control of one or more processors 1032, the one or more processors 1032, and one or more storage devices 1033 storing computer-readable instructions which, when executed by the one or more processors 1032, enables the one or more processors 1032 to perform the method 1100 for controlling a vehicle.

Examples of the one or more storage devices of the mobile apparatus 101 or the electronic device 103 include a random access memory (hereinafter “RAM”), a dynamic random access memory (hereinafter “DRAM”), a static random access memory (hereinafter “SRAM”), any other form of volatile memory known in the art, a magnetic hard disk, an optical disk, a floppy disk, a flash memory, an electrically programmable memory (hereinafter “EPROM”), an electrically erasable and programmable memory (hereinafter “EEPROM”), any other form of non-volatile memory known in the art, a data server, etc.

In addition, examples of the one or more processors of the mobile apparatus 101 or the electronic device 103 include a central processing unit (hereinafter “CPU”), a vision processing unit (hereinafter “VPU”), a graphics processing unit (hereinafter “GPU”), a tensor processing unit (hereinafter “TPU”), an ECU, a VCU, an MCU, a BCU, a DCU, a neural processing unit (hereinafter “NPU”), a neural processing engine, or another processing device, an application processor, a display controller, an application specific integrated circuit (hereinafter “ASIC”), a field programmable gate array (hereinafter “FPGA”), a coprocessor, or any other hardware configured to function as a processing unit.

What is claimed is:

1. A method for controlling a vehicle, the method being implemented by a mobile apparatus configured to be connected to and disconnected from the vehicle through a communication interface, the method comprising:
connecting to the vehicle via the communication interface;
determining that a user associated with the apparatus is authorized to operate the vehicle; and
controlling, after the vehicle has been powered up, the vehicle via the communication interface to enable the vehicle to perform a function that affects the operation of the vehicle.

2. The method according to claim 1, wherein the function is implemented by an operating system having a first portion executed in the mobile apparatus and a second portion that differs from the first portion executed in a computing device of the vehicle.

3. The method according to claim 1, further comprising, prior to the controlling step:
generating a control signal based on data received from a sensing device of the vehicle, wherein the controlling step comprises:
transmitting the control signal to an actuator device of the vehicle to enable the actuator device to perform the function.

4. The method according to claim 1, further comprising, prior to determining that the user is authorized to operate the vehicle:
receiving information identifying the user or digital credential data from the user, wherein the determining step further comprises a step of authenticating (S5020 the user based on the received information or the received digital credential data.

5. The method according to claim 1, further comprising, after the determining step:
verifying whether the authorized user controls the vehicle or whether the user is still authorized to operate the vehicle.

6. The method according to claim 1, further comprising:
locating the vehicle using GPS data; and
verifying if, in accordance with a location of the vehicle, the user is authorized to operate the vehicle at this location.

7. The method according to claim 1, further comprising:
generating an alert signal rendered in the vehicle or configured to be rendered to a distant third party when a predefined condition is met.

8. The method according to claim 1, further comprising:
transmitting a digital key to the vehicle to request control of the vehicle.

9. The method according to claim 1, further comprising, prior to the determining step:
determining that the user associated with the apparatus is on a seat of the vehicle.

10. A method for controlling a vehicle, the method being implemented by an electronic device and comprising:
receiving a request from a mobile apparatus associated with a user for permission to operate the vehicle;
determining that the user is authorized to operate the vehicle; and
communicating with the mobile apparatus to allow the user to control the vehicle.

11. A mobile apparatus for controlling a vehicle, the mobile apparatus being configured to be connected to and disconnected from the vehicle through a communication interface and comprising:
the communication interface, configured to connect the apparatus to the vehicle;
an authentication module configured to determine that a user associate with the apparatus is authorized to operate the vehicle; and
a controller configured to control, after the vehicle has been powered up, the vehicle via the communication interface to enable the vehicle to perform a function that affects the operation of the vehicle.

12. The mobile apparatus according to claim 11, wherein the function is implemented by an operating system having a first portion executed in the mobile apparatus and a second portion that differs from the first portion executed in a computing device of the vehicle.
